(19) United States
(12) Patent Application Publication
(10) Pub. No.: US 2006/0164396 A1
(43) Pub. Date: Jul. 27, 2006

(54) Synthesizing mouse events from input device events

(75) Inventor: David R. Anderson, Saratoga, CA (US)

Correspondence Address: VIERRA MAGEN/MICROSOFT CORPORATION, 575 MARKET STREET, SUITE 2500, SAN FRANCISCO, CA, 94105, US

(73) Assignee: Microsoft Corporation, Redmond, WA (US)

(21) Appl. No.: 11/044,320

(22) Filed: Jan. 27, 2005

(51) Int. Cl. G06F 9/00

(52) U.S. Cl. 345/172; 715/827

(57) ABSTRACT

Mouse events are synthesized from input received from input devices other than a mouse. Input received is used to select focusable regions in an interface. The input can include navigation input triggering movement between focusable regions or region select input select a currently focused region. pointer events are generated in response to received navigation and region select input. In one embodiment, the interface may include a GUI, web page, or some other type of interface that includes components that can be selected by a mouse device.

### BACKGROUND OF THE INVENTION

1. Field of the Invention

The present invention is directed to synthesizing pointer events in response to receiving input.

2. Description of the Related Art

Many web pages currently on the internet are designed with the assumption that a mouse or similar pointer device will be used to interact with and navigate through the page. Such pages include components that can be selected by a mouse device, such as hyperlinks, images, web page navigation buttons, and other web page components. To select or otherwise engage these components, a user is required to move a cursor controlled by a mouse over the component. In some cases, a user must also press a mouse button to engage additional functionality associated with the web page component. For example, to open a window associated with a hyperlink, a user must use a mouse device to position a cursor over the hyperlink and then click a mouse button.

Web pages typically require one or more mouse events in order to experience the full capability of the web page. For example, a “mouse-move” event positions a cursor, “mouse-over” event initiates drop down windows or provides other information regarding a component, and “mouse-down” and “mouse-up” events indicate a mouse button has been pressed down and then released. Other web pages utilize drop down menus activated by mouse movement events. These menus cannot be accessed by current browsers using keyboard input such as a “tab” key to navigate the web page. The functionality of these pages is difficult to engage without a mouse device, thereby affecting the user experience for users without a mouse.

In addition, some web pages are designed to capture keyboard events and change or block their default behavior. For example, some web pages capture input associated with the “Enter” key and ignore it. This makes selection of a link and other components within the web page interface impossible using current keyboard devices.

Some existing systems perform functions associated with a limited number of mouse events. For example, the end result of selecting a hyperlink using a mouse may be retrieving a web page from a server and displaying the web page in a new window. Some systems may detect a keyboard selection of the hyperlink and directly proceed to retrieve the web page from the server. Though the same end result can be achieved using a keyboard, the mouse events are not generated. Such a system is not practical for interfaces with a large number of mouse selectable components or for large numbers of web pages.

Additionally, anchors associated with the selected component often have parent or children elements embedded within the selected anchor (or in which the selected anchor is embedded in). As a result, features associated with the parent or children elements are not engaged by systems that perform functions associated with specific anchors rather than generate mouse events at the location of the anchors themselves.

### SUMMARY OF THE INVENTION

The present invention includes a method for synthesizing pointer events. The method begins with receiving input from a keyboard. A focusable region within an interface is then selected from the input. Next, one or more pointer events is generated. The generated one or more pointer events are associated with the focusable region. The input received may include navigation input or region select input.

In one embodiment, a method for synthesizing pointer events may include receiving navigational input. A focusable region within an interface is then selected from the navigational input. After the input is received, a cursor point is determined within the focusable region. One or more pointer events associated with the focusable region are then generated.

In one embodiment, an apparatus that synthesizes pointer events may include a storage device, an input device, a region selector, and a pointer event generator. The storage device can include focusable region information. The region selector is able to select a region associated with the focusable region information in response to receiving input from the input device. The pointer event generator is able to generate a pointer event associated with the selected region in response to selection of that region.

### BRIEF DESCRIPTION OF THE DRAWINGS

FIG. 1 illustrates one embodiment of a network environment.

FIG. 2 illustrates one embodiment of a computing environment.

FIG. 3 illustrates one embodiment of a broadcast enabled computing device.

FIG. 4A illustrates one embodiment of an interface having focusable regions.

FIG. 4B illustrates one embodiment of a detailed view of a focusable region.

FIG. 4C illustrates another embodiment of an interface having focusable regions.

FIG. 4D illustrates another embodiment of an interface having focusable regions.

FIG. 4E illustrates another embodiment of an interface having focusable regions.

FIG. 5 illustrates one embodiment of a method for processing input.

FIG. 6 illustrates one embodiment of a method for generating a focusable element table.

FIG. 7 illustrates one embodiment of a focusable element table.

FIG. 8A illustrates one embodiment of a method for calculating the center of a first rectangle within a focusable region.

FIG. 8B illustrates one embodiment of a focusable region for which the center of a first rectangle is calculated.

FIG. 9 illustrates one embodiment of a method for firing a mouse move event.

FIG. 10 illustrates one embodiment of a keyboard device for use with the present invention.

### DETAILED DESCRIPTION

Pointer events associated with a mouse, tablet or touch pad are synthesized from input received from input devices other than a mouse. The input received can include navigation input or region select input and select a focusable region within an interface. Navigation input allows a user to move a focus from one focusable region to another. Region select input selects the current focusable region and typically engages or initiates some type of function associated with the region. In one embodiment, the interface may include a GUI, web page, or some other type of interface that includes components that are selectable by a mouse device.

The interface is provided on a display by a browser or operating system. The interface includes one or more focusable regions on which mouse events can be fired (including regions normally subject to selection by a mouse). A user can provide input from devices other than a mouse to select the focusable regions. Though pointer events can include events synthesized in response to receiving input from one of many types of input devices, mouse events will be discussed below for purposes of simplifying the discussion. Thus, where mouse events are referred to, it is intended that other types of pointer events can be used interchangeably.

Navigation input changes a focus from one focusable region to another within an interface. Navigation input maps keys to directions for indicating in which direction the focus should move. For example, navigation key mapping may include mapping an up arrow key with a “move focus up”, down arrow key with a “move focus down”, etc. Any input mechanism can be used to provide navigation input, including arrow keys, tab keys, or any other key from a keyboard, an IR signal from an IR source (such as a phone, personal digital assistant or computer), or some other input device other than a mouse. In some embodiments, a map of regions within the interface is maintained in the form of a table or some other format. Once the navigation input is received, the newly selected focusable region is accessed from the table and becomes the focused region. Mouse events are then generated as if a cursor was placed at a position associated within the focused region. In one embodiment, the cursor is positioned to the center of the focused region. This is discussed in more detail below.

Region select input can be entered to select a function or the functionality associated with a region. Focused region select input can be received from a dedicated key on a keyboard or any other key from an input device other than a mouse device. When received, an application will engage the functionality associated with the currently focused region. For example, receiving a focused region select input for a currently focused region can cause a drop-down menu to appear, a new window to appear, a hyper-link to be activated, or some other function. This is discussed in more detail below.

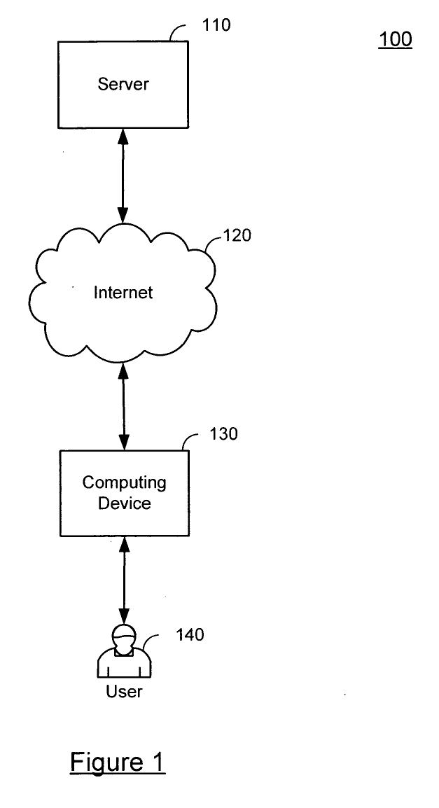

FIG. 1 illustrates one embodiment of a network environment that can be used with the present invention. Network environment 100 of FIG. 1 includes server 110, Internet 120, computing device 130, and user 140. The computing device can include an input device, display, one or more processors, memory and other components. The user provides input to a computing device through the input device. In one embodiment, the one or more processors can execute instructions stored in memory to provide an interface on the display. The computing device can generate mouse events in response to receiving input through the input device, such as a keyboard. In some embodiments, the interface can be a web page provided by server 110 over the Internet 120.

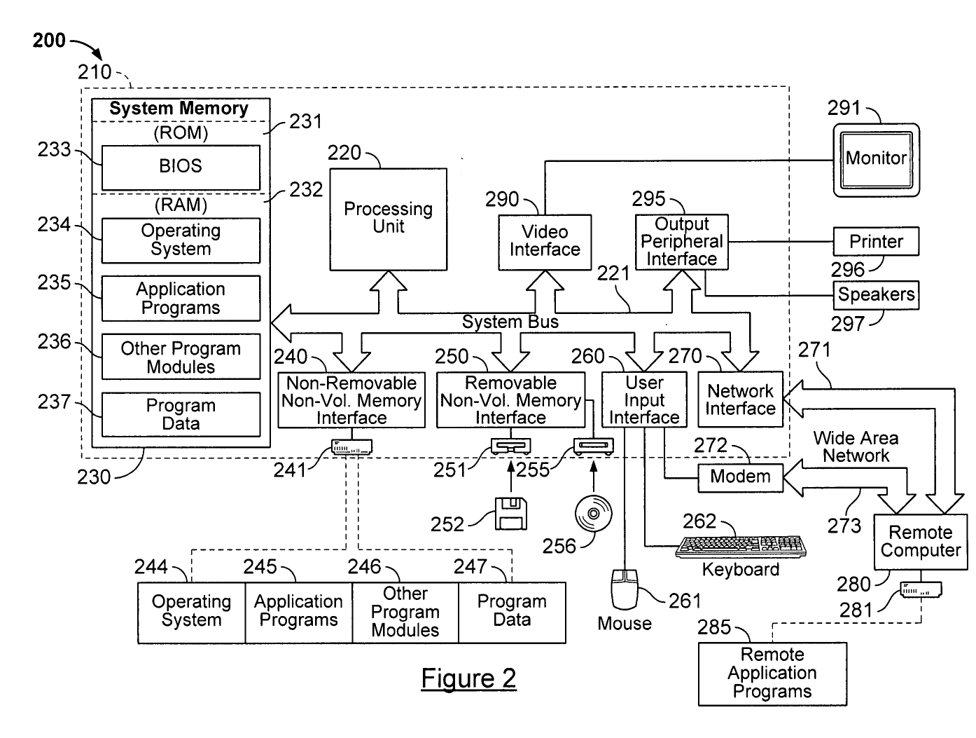

FIG. 2 illustrates one embodiment of a computing system environment in which the present invention can be used. In one embodiment, computing device 130 of FIG. 1 can be implemented by the computing environment of FIG. 2. The computing system environment 200 is only one example of a suitable computing environment and is not intended to suggest any limitation as to the scope of use or functionality of the invention. Neither should the computing environment 200 be interpreted as having any dependency or requirement relating to any one or combination of components illustrated in the exemplary operating environment 200.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 2, an exemplary system for implementing the invention includes a general purpose computing device in the form of a computer 210. Components of computer 210 may include, but are not limited to, a processing unit 220, a system memory 230, and a system bus 221 that couples various system components including the system memory to the processing unit 220. The system bus 221 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 210 typically includes a variety of computer readable media. Computer readable media can be any available media that can be accessed by computer 210 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 210. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 230 includes computer storage media in the form of volatile and/or nonvolatile memory such as read only memory (ROM) 231 and random access memory (RAM) 232. A basic input/output system 233 (BIOS), containing the basic routines that help to transfer information between elements within computer 210, such as during start-up, is typically stored in ROM 231. RAM 232 typically contains data and/or program modules that are immediately accessible to and/or presently being operated on by processing unit 220. By way of example, and not limitation, FIG. 2 illustrates operating system 234, application programs 235, other program modules 236, and program data 237.

The computer 210 may also include other removable/non-removable, volatile/nonvolatile computer storage media. By way of example only, FIG. 2 illustrates a hard disk drive 240 that reads from or writes to non-removable, nonvolatile magnetic media, a magnetic disk drive 251 that reads from or writes to a removable, nonvolatile magnetic disk 252, and an optical disk drive 255 that reads from or writes to a removable, nonvolatile optical disk 256 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 241 is typically connected to the system bus 221 through an non-removable memory interface such as interface 240, and magnetic disk drive 251 and optical disk drive 255 are typically connected to the system bus 221 by a removable memory interface, such as interface 250.

The drives and their associated computer storage media discussed above and illustrated in FIG. 2, provide storage of computer readable instructions, data structures, program modules and other data for the computer 210. In FIG. 2, for example, hard disk drive 241 is illustrated as storing operating system 244, application programs 245, other program modules 246, and program data 247. Note that these components can either be the same as or different from operating system 234, application programs 235, other program modules 236, and program data 237. Operating system 244, application programs 245, other program modules 246, and program data 247 are given different numbers here to illustrate that, at a minimum, they are different copies. A user may enter commands and information into the computer 20 through input devices such as a keyboard 262 and pointing device 261, commonly referred to as a mouse, trackball or touch pad. Other input devices (not shown) may include a microphone, joystick, game pad, satellite dish, scanner, or the like. These and other input devices are often connected to the processing unit 220 through a user input interface 260 that is coupled to the system bus, but may be connected by other interface and bus structures, such as a parallel port, game port or a universal serial bus (USB). A monitor 291 or other type of display device is also connected to the system bus 221 via an interface, such as a video interface 290. In addition to the monitor, computers may also include other peripheral output devices such as speakers 297 and printer 296, which may be connected through a output peripheral interface 290.

The computer 210 may operate in a networked environment using logical connections to one or more remote computers, such as a remote computer 280. The remote computer 280 may be a personal computer, a server, a router, a network PC, a peer device or other common network node, and typically includes many or all of the elements described above relative to the computer 210, although only a memory storage device 281 has been illustrated in FIG. 2. The logical connections depicted in FIG. 2 include a local area network (LAN) 271 and a wide area network (WAN) 273, but may also include other networks. Such networking environments are commonplace in offices, enterprise-wide computer networks, intranets and the Internet.

When used in a LAN networking environment, the computer 210 is connected to the LAN 271 through a network interface or adapter 270. When used in a WAN networking environment, the computer 210 typically includes a modem 272 or other means for establishing communications over the WAN 273, such as the Internet. The modem 272, which may be internal or external, may be connected to the system bus 221 via the user input interface 260, or other appropriate mechanism. In a networked environment, program modules depicted relative to the computer 210, or portions thereof, may be stored in the remote memory storage device. By way of example, and not limitation, FIG. 2 illustrates remote application programs 285 as residing on memory device 281. It will be appreciated that the network connections shown are exemplary and other means of establishing a communications link between the computers may be used.

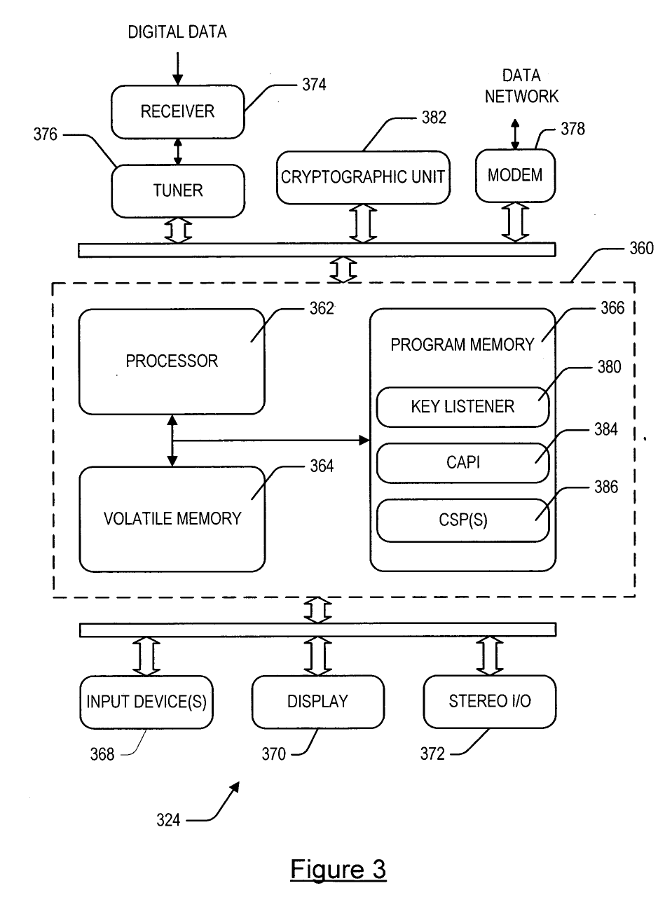

FIG. 3 illustrates another embodiment of an computing system environment 324 in which the present invention can be used. In one embodiment, computing system 324 can be used to implement computing device 130 of FIG. 1. Certain features of the invention are particularly suitable for use with a broadcast enabled computer which may include, for example, a set top box. FIG. 3 shows an exemplary configuration of an authorized client 324 implemented as a broadcast-enabled computer. It includes a central processing unit 360 having a processor 362, volatile memory 364 (e.g., RAM), and program memory 366 (e.g., ROM, Flash, disk drive, floppy disk drive, CD-ROM, etc.). The client 324 has one or more input devices 368 (e.g., keyboard, mouse, etc.), a computer display 370 (e.g., VGA, SVGA), and a stereo I/O 372 for interfacing with a stereo system.

The client 324 includes a digital broadcast receiver 374 (e.g., satellite dish receiver, RF receiver, microwave receiver, multicast listener, etc.) and a tuner 376 which tunes to appropriate frequencies or addresses of the broadcast network. The tuner 376 is configured to receive digital broadcast data in a particularized format, such as MPEG-encoded digital video and audio data, as well as digital data in many different forms, including software programs and programming information in the form of data files. The client 324 also has a modem 378 which provides dial-up access to the data network 328 to provide a back channel or direct link to the content servers 322. In other implementations of a back channel, the modem 378 might be replaced by a network card, or an RF receiver, or other type of port/receiver which provides access to the back channel.

The client 324 runs an operating system which supports multiple applications. The operating system is preferably a multitasking operating system which allows simultaneous execution of multiple applications. The operating system employs a graphical user interface windowing environment which presents the applications or documents in specially delineated areas of the display screen called “windows.” One preferred operating system is a Windows® brand operating system sold by Microsoft Corporation, such as Windows® 95, Windows® NT, Windows®XP or other derivative versions of Windows®. It is noted, however, that other operating systems which provide windowing environments may be employed, such as the Macintosh operating system from Apple Computer, Inc. and the OS/2 operating system from IBM.

The client 324 is illustrated with a key listener 380 to receive the authorization and session keys transmitted from the server. The keys received by listener 380 are used by the cryptographic security services implemented at the client to enable decryption of the session keys and data. Cryptographic services are implemented through a combination of hardware and software. A secure, tamper-resistant hardware unit 382 is provided external to the CPU 360 and two software layers 384, 386 executing on the processor 362 are used to facilitate access to the resources on the cryptographic hardware 382. The software layers include a cryptographic application program interface (CAPI) 384 which provides functionality to any application seeking cryptographic services (e.g., encryption, decryption, signing, or verification). One or more cryptographic service providers (CSPs) 386 implement the functionality presented by the CAPI to the application. The CAPI layer 384 selects the appropriate CSP for performing the requested cryptographic function. The CSPs 386 perform various cryptographic functions such as encryption key management, encryption/decryption services, hashing routines, digital signing, and authentication tasks in conjunction with the cryptographic unit 382. A different CSP might be configured to handle specific functions, such as encryption, decryption, signing, etc., although a single CSP can be implemented to handle them all. The CSPs 386 can be implemented as dynamic linked libraries (DLLs) that are loaded on demand by the CAPI, and which can then be called by an application through the CAPI 384.

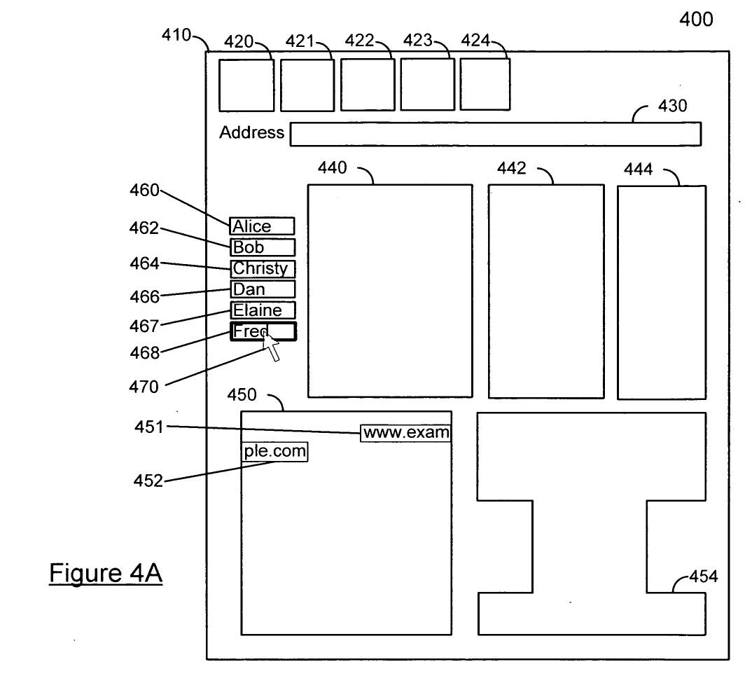

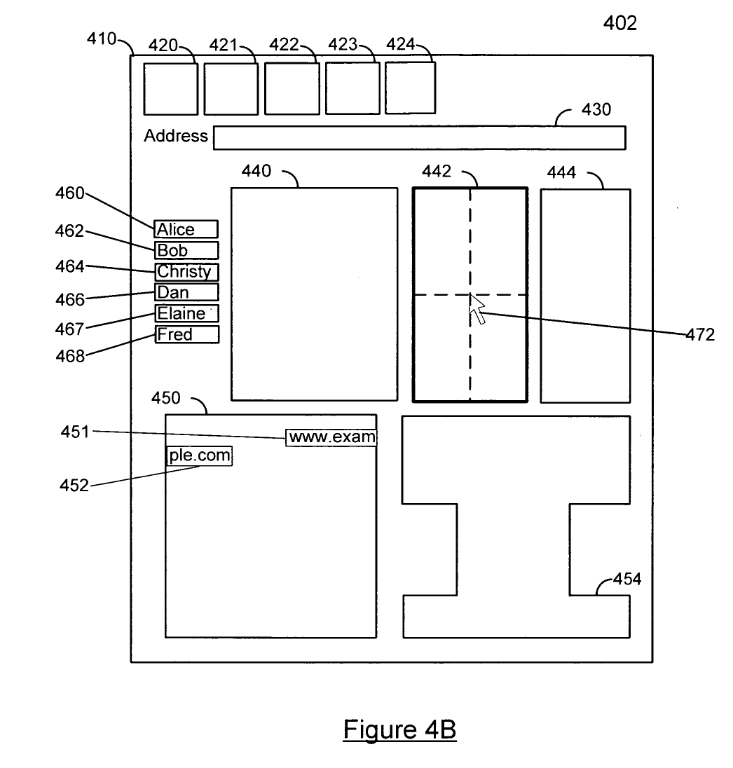

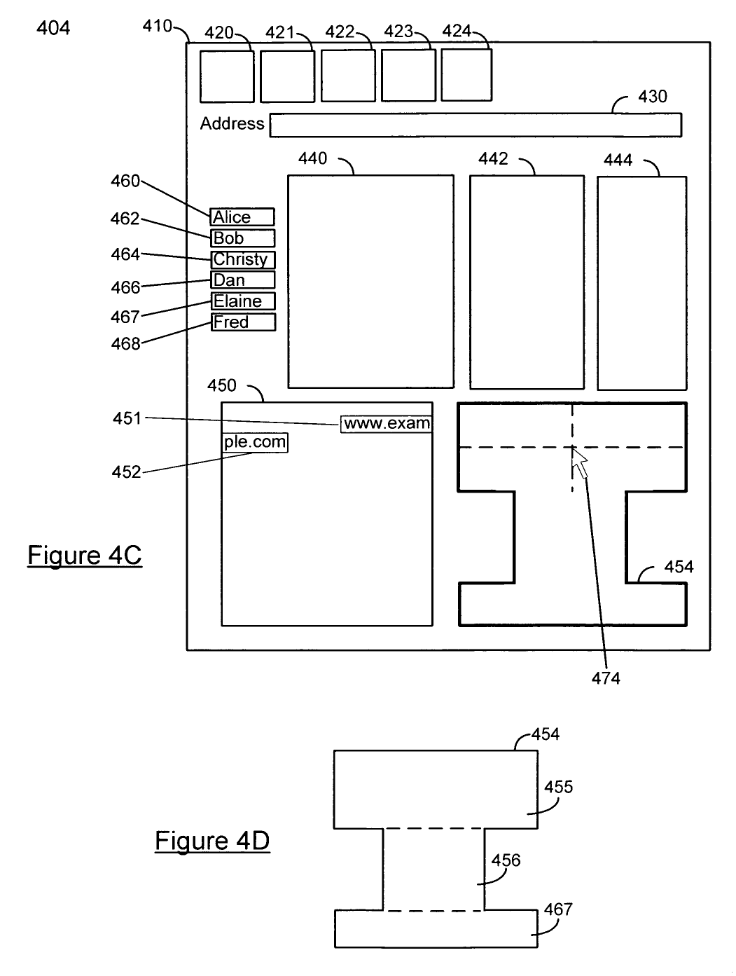

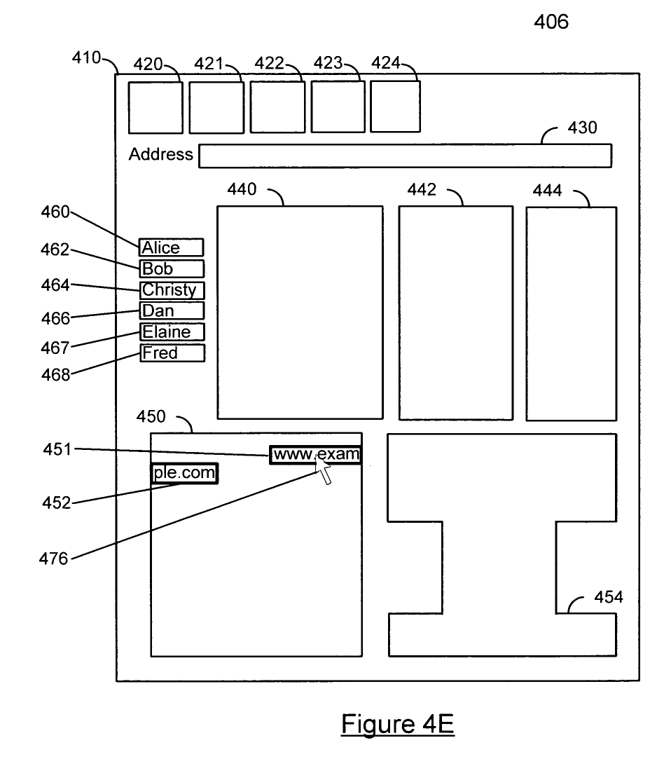

FIG. 4A illustrates one embodiment of an interface 400 provided by an application performing the present invention. In one embodiment, interface 400 is a web page provided by a web browser. Interface 400 includes interface action buttons 420, 421, 422, 423, and 424, address bar 430, content regions 440, 442, 444, 450, and 454, URL link regions 451 and 452, and links 460, 462, 464, 466, 467, and 468. Cursor 470 is located over link 468.

Interface action buttons 420-424 are located near the top of interface 400 and can be selected by a user using navigation and focus region select input. Interface action buttons can provide actions to web site such as refresh current URL, to last page URL, stop loading URL, etc. Address bar 430 indicates an address or URL for interface 400. Content regions 440-454 may include interface content such as graphics, text, hyper-links, or any other type of digital content. Content regions may encompass one or more focusable regions (such as one or more hyperlinks) or comprise one focusable region (such as a digital image). In one embodiment, focusable content regions may be contained in an anchor. The URL link www.example.com displayed in content region 450 is wrapped around the right edge of the region 450. As a result, the URL link is divided into a first link region 451 and a second link region 452. Links 460-468 comprise separate focusable regions. The focusable region consisting of link 468 is currently selected in interface 400. As a result, cursor 470 is placed at the center of the rectangle comprising the area of the link and the border of the link is highlighted with a thick black border. In FIG. 4A, the interface action buttons, address bar, content regions and links are all focusable regions.

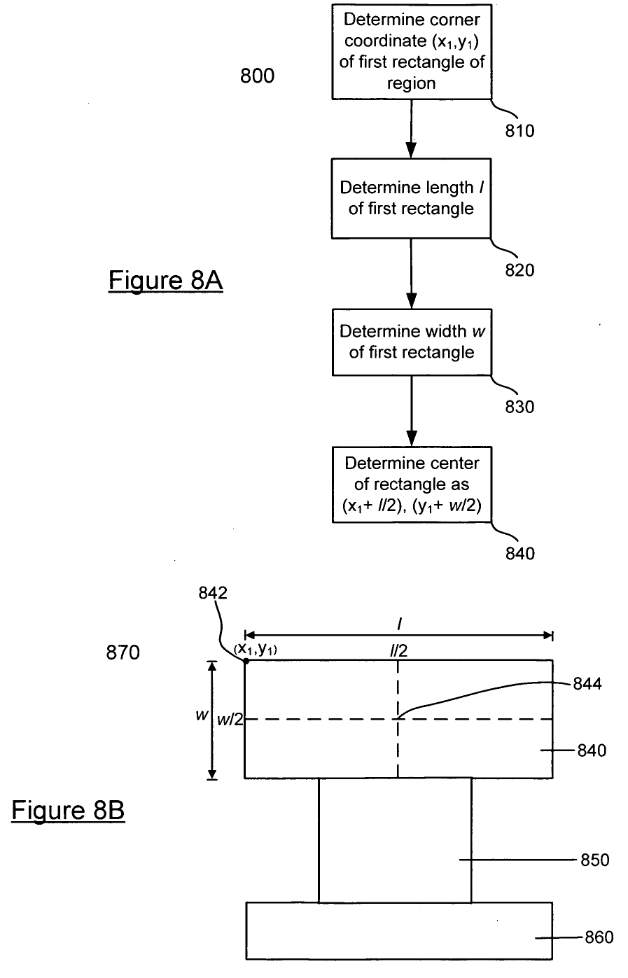

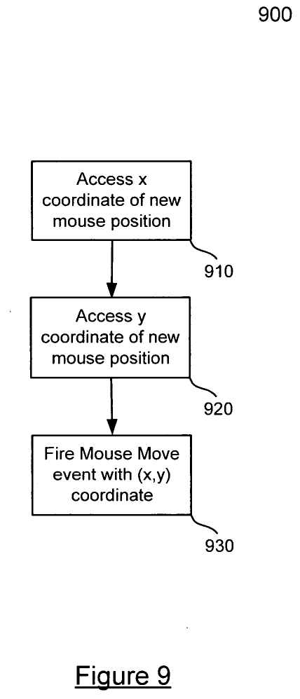

FIG. 4B illustrates one embodiment of an interface provided by an application performing the present invention. Interface 402 of FIG. 4B is similar to interface 400 of FIG. 4A except that the focused region is content region 442. In one embodiment, content region 442 (and other content regions that are focusable) is contained in an anchor. In one embodiment, once a focusable region is selected, a cursor is positioned in the center of the focusable region. Accordingly, cursor 472 is positioned in the center of content region 442. Positioning a cursor is discussed in more detail in FIG. 8A below.

In one embodiment, a focusable region may be comprised of one or more sub-regions. The sub-regions may have a shape, such as a rectangle, square, circle, triangle, an abstract shape or some other shape. For purposes of discussion, sub-regions in the shape of rectangles are discussed herein. For example, FIG. 4D illustrates a detailed view of content region 454 of FIG. 4A divided into rectangle shaped sub-regions. Region 454 as illustrated in FIG. 4D includes first rectangle sub-region 455, second rectangle sub-region 456, and third rectangle sub-region 457.

FIG. 4C illustrates an embodiment of an interface 404 provided by an application performing the present invention. Interface 404 of FIG. 4C is similar to interface 400 of FIG. 4A except that the focused region is content region 454. In one embodiment, when a focusable region is comprised of two or more rectangle sub-regions, the cursor is positioned at the center of the first rectangle. In other embodiments, the cursor may be positioned at any other sub region of a focusable region. In one embodiment, the first rectangle is the first rectangle described in the interface description for the focusable region. This is discussed in more detail below. In the embodiment illustrated in FIG. 4C, cursor 474 is positioned at the center of the first rectangle sub-region 455 within region 454.

FIG. 4E illustrates an embodiment of an interface 406 provided by an application performing the present invention. Interface 406 of FIG. 4E is similar to interface 400 of FIG. 4A except that the focused region is link comprised of link portion 451 and 452. The first rectangle of the link is link region 451. Accordingly, cursor 476 is positioned at the center of the link 451. In this example, selecting the center of the first rectangular sub-regions is advantageous over placing the cursor in the center of a bounding box encompassing the entire focusable region (here, the entire split link). A cursor positioned in the center of a bounding box encompassing the split link would not be placed over either link portion. Thus, the link could not be accessed.

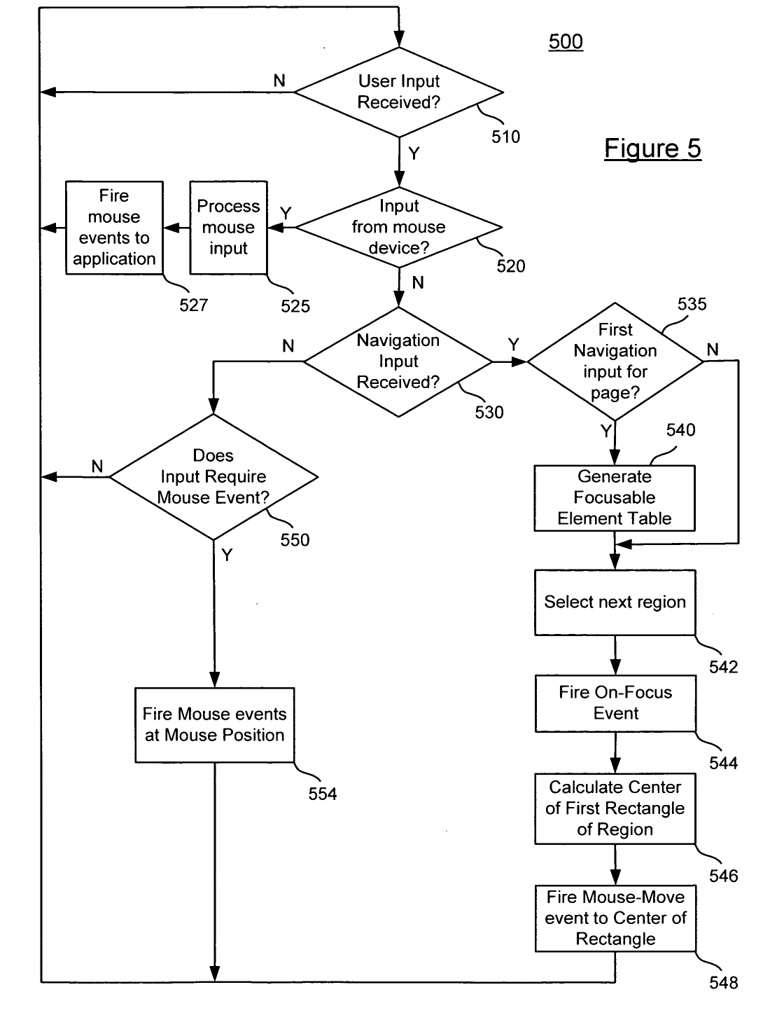

FIG. 5 illustrates one embodiment of a method for processing input to synthesize mouse events. In one embodiment, method 500 is performed by an application stored in memory of a computing device and run by one or more computing device processors. For example, method 500 can be performed by a network browser application. In some embodiments, method 500 can be performed by other software, such as an operating system. First, the system determines whether input from a user is received at step 510. If no input is received, operation remains at step 510. If input is received from a user, operation continues to step 520.

At step 520, the system determines whether the input received is from a pointing device, such as a mouse. In one embodiment, a message handler processes the input and makes the determination. If the input is from a pointing device, the pointing device input is processed at step 525. Next, mouse events are fired to an application at step 527. When the application is a web page, mouse events are fired to the web page. The application can be a web page, dialog box or other hosted application object. Operation then returns to step 510. If the input is not received from a pointing device, operation continues to step 530. Next, the system determines whether navigation input was received at Step 530. If navigation input is not received, operation continues to step 550. If navigation input is received, operation continues to step 535.

The system determines whether the navigation input received is the first navigation input received for the current interface page at step 535. In one embodiment, for each interface page, the first navigation input received triggers the generation of a focusable region table. Generating a focusable region table after receiving the first navigation input prevents unnecessary processing in case no navigation key is received for the interface page. If the navigation input received is not the first navigation input received for the interface page, operation continues to step 542. If the navigation input received is the first navigation input received for the interface page, operation continues to step 540.

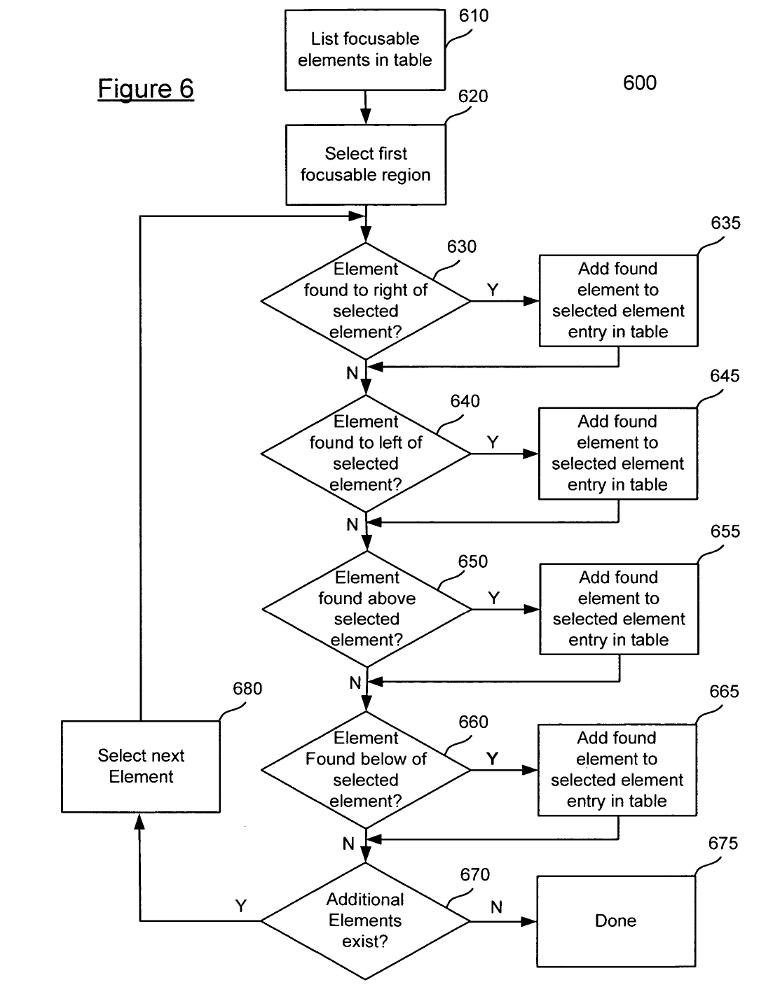

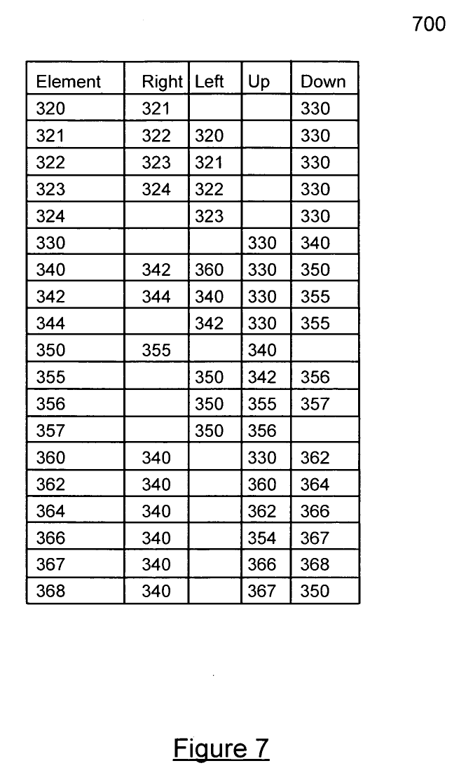

The system generates a focusable region table at step 540. The focusable region table lists the focusable regions within the current interface page. The table also includes information regarding the position of other focusable regions with respect to each other within the interface. Generation of a focusable region table is discussed in more detail below with respect to FIG. 6. An example of a focusable region table is illustrated in FIG. 7 and discussed in more detail below. In other embodiments, focusable region information and inter-region positioning may be collected and stored in a format other than a table. For example, focusable region information may be included in a list or some other format within memory. After the focusable region table is generated, operation continues to step 542.

The next focusable region is selected by the system at step 542. In one embodiment, the next focusable region is selected from the received navigation input and the focusable region table generated at step 540 (or from some other file or data format that contains the focusable region mapping). For example, if the currently focused region is region 442 of FIG. 4A and “move down” navigation input is received, the system will select region 454 (the focusable region below focused region 442) as the next focused region. After the next focusable region is selected, an on-focus event is fired at step 544. The on-focus event indicates to the operating system that a new focusable region has been made the focused region. In some embodiments, after an on-focus event is fired, the focusable region may be highlighted. In FIGS. 4A, 4B, 4C and 4E, the focused region is highlighted with a thick black border.

The center of the first rectangle of a selected focusable region is calculated at step 546. Examples of selected regions are illustrated in FIGS. 4A, 4B, 4C and 4E. In FIG. 4A, the selected focusable region is link 468. The area of link 468 is a rectangle. Accordingly, the center of the region is the center of the link. Cursor 470 is positioned at the center of link 468 in FIG. 4A. In FIG. 4B, content region 442 is the focused region. As a result, cursor 472 is positioned at the center of the rectangle comprising focused region 442. In FIG. 4C, content region 454 is the focused region. Of the three rectangles comprising content region 454, the center of the first rectangle is calculated. As illustrated in FIG. 4C, cursor 474 is placed at the center of the first rectangle of region 454. For region 452 of FIG. 4E, the first rectangle of the focused region is link portion 451. Thus, the center of link portion 451 is calculated upon selection of the link. The step of calculating the center of a first rectangle within a focusable region is discussed in more detail with respect to FIG. 8A below. In some embodiments, a point associated with a cursor can be calculated for other shapes and positions within that shape for a focusable region.

After calculating the center of the first rectangle of a focusable region, the current system fires a mouse-move event to the center of the rectangle at step 548. This simulates a mouse-move event from a location associated with the previous cursor location to the center of the first rectangle within the selected focusable region. This differs from selecting a region without affecting the cursor location as performed in other systems (such as conventional tab navigation of prior systems). Firing a mouse-move event to the center of a rectangle is discussed in more detail below with respect to FIG. 9.

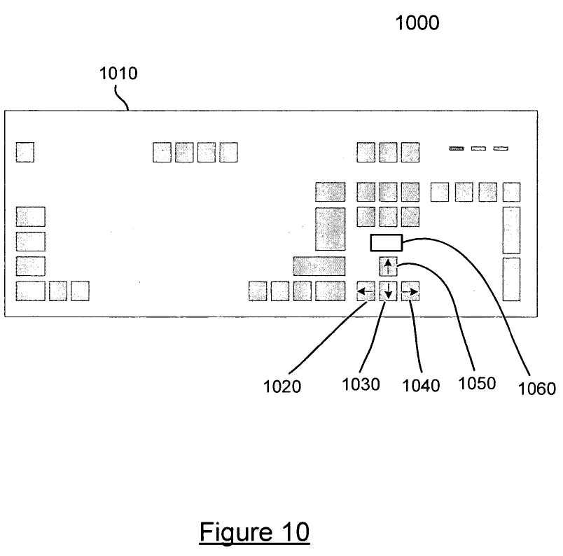

If navigation input is not received at step 530, the system determines whether the input requires a mouse event at step 550. In one embodiment, at step 550, the system determines whether the input received is mapped as a focused region select input such that a right mouse button click should be simulated. The simulated right mouse button input may be implemented on a keyboard or some other input device. In one embodiment, the key may be implemented as an additional dedicated key on a keyboard. An example of a keyboard with a right mouse button input key able to be mapped as a focused region select input is illustrated in FIG. 10 and discussed below. The focused region select input that requires a mouse event may be mapped to a virtual key code or any other key code as configured by the system. If the input received at step 510 is determined not to require a mouse event at step 550, operation continues to step 510 where the system awaits the next user input. If the input received does require a mouse event, operation continues to step 554.

One or more mouse events are fired at the current cursor position within the current focused region at step 554. The mouse events fired at step 554 may include a mouse down event and a mouse up event (emulating the events fired by pressing a right mouse button “down” and letting the button spring back “up”), or a mouse select event. As a result of firing the one or more mouse events at the mouse position at step 554, functions associated with the focusable region are performed. These functions can include retrieving content associated with a link, opening or closing a window, sending information to a server, causing a drop down menu to be displayed, or some other function as encoded within the description of the interface. After the mouse events have fired at step 554, operation continues to step 510.

Method 600 of FIG. 6 illustrates a method for generating a focusable region table as discussed above in step 540 of method 500. Method 500 begins with listing focusable regions in the table at step 610. In one embodiment, the system accesses description or code associated with the interface or page associated with the table. In an embodiment where the interface is a webpage, the HTML code associated with the web page is accessed. The accessed description or code is then parsed to detect the focusable regions within the page. For example, in the case of a webpage, HREF, on-click, tab events, and other anchors allowing selection of a component of an interface are retrieved during the parsing. The focusable regions detected during parsing are then inserted as focusable region entries into a column of the focusable region table at step 610. In table 700 of FIG. 7, the focusable regions of interface 400 of FIG. 4A are listed in the first column of the table.

The first region of a table is selected at step 620. For table 700, this would correspond to region 420. Steps 630-665 generate a map for each selected region of a focusable region table. The system determines whether a region is found to the right of the first selected region at step 630. In one embodiment, the system determines positions of regions while parsing the code at step 610. If a focusable region is found to the right of the currently selected region from the table, the focusable region found is added to the selected region entry in the appropriate column of focusable region table at step 635. Operation then continues to step 640. If no focusable region is found to the right of the selected region, this indicates that the interface may not allow navigation in this direction. For example, content region 444 is located on the right-most side of interface 400. Since no region exists to the right of content region 444, operation would continue from step 630 to step 640 for region 444. Different navigation algorithms may be used to determine navigation between multiple focusable regions in a particular direction.

In one embodiment, an application may allow wrap-around navigation between focusable regions of an interface. In this case, if no regions exist (for example) to the right of a currently selected region from a focusable region table, the application may map to a focusable region on the opposite side of the interface. This will implement a wrap-around effect.

The system determines whether a region is found to the left of the selected region at step 640. If a region is found to the left of the selected region, operation continues to step 645. If a region is not found to the left of the selected region, operation continues to step 650. At step 645, the system adds the region found to the left of the selected region to the selected region entry in the table. This is similar to the step 635 discussed above. Operation then continues to step 650. The system determines whether a focusable region is found above the selected region at step 650. If a focusable region is found above the selected region, operation continues to step 655 where the focusable region is added to the region entry in the table. If no focusable region is found above the selected region, operation continues to step 660. After adding the focusable region to the selected region at step 655, operating continues to step 660.

The system determines whether a focusable region is found below the selected region at step 660. If a focusable region is found below the selected region, operating continues to step 665 where the focusable region is added to the selected region entry in the table. Operation then continues to step 670. If no region is found below the selected region at step 660, operation continues to step 670.

Steps 630 through 665 of method 600 are used to map focusable regions of an interface with respect to each other from a description or code associated with the interface. In the illustrated embodiment, the focusable regions are mapped together using up, down, left, and right navigational information. In some embodiments, other directions may use to map regions together. Other directions may include diagonal navigation, including above-left, above-right, below-left, or below-right. Additionally, directions such as double-left or triple-left or some similar direction may be mapped to navigate to a focusable region located more than one focusable region position in a particular direction.

The system determines whether additional focusable regions exist at step 670. If no additional focusable regions exist in a table, then the entire interface has been mapped and operation ends at step 675. If additional regions exist, the next region is selected at step 680 and operation continues to step 630.

In one embodiment, due to interface design and the variety of shapes a focusable region may have, neighboring focusable regions may not necessarily be reciprocally mapped together. For example, in FIG. 4A, content region 440 is positioned to the right of links 460-468 in interface 400. In this case, when any of links 460-468 are the focused region and a “right” navigation input is received, content region 440 will become the focused region. However, when content region 440 is the focused region and “left” navigation input is received, the upper-most focusable region in the direction of the navigation input (link 460) becomes the focused region. Links 462-468 in this case, although located to the left of content region 440, will not become focused as a result of the navigation input. In this embodiment, when more than one focusable region is positioned in the direction of a “left” or “right” navigation input, the uppermost focusable region will become the focused region. In another example, if region 440 is currently selected and “down” navigation input is received, the next focused region will be the upper portion of the link of content region 450, link portion 451. Similarly, if region 454 is currently focused and a “left” navigation input is received, link portion 451 will become the focused region. In yet another example, if address bar 430 is the focused link and a “down” navigation input is received, content region 440 will become the focused link. In this embodiment, when more than one focusable region is positioned in the direction of an “up” or “down” navigation input, the region positioned to the left will become the focused region. This priority system is based on position alone. Other priority systems can be used that take into account other parameters besides position, such as size, weighting, type of focusable region (link v. image), and other parameters.

FIG. 7 illustrates a focusable region table 700 such as that generated by method 600. In one embodiment, the first column of the table lists all the focusable regions within an interface. The subsequent columns of the focusable region table contain mapping information for regions surrounding the focusable regions in the first column. In the embodiment illustrated, the mapping information includes regions to the right, left, up, and down from the listed focusable regions entries. For example, for region 440, the table lists region 442 to the right, region 460 to the left, region 430 to the above direction, and region 350 located down from region 340. For region 450, region 455 is listed to the right of region 450, and region 440 is listed above region 450. No regions are listed to the left or below of region 450. The focusable regions illustrated and corresponding mapping information of the focusable region table 700 of FIG. 7 represents one embodiment of mapping regions of FIG. 4A. In some embodiments, a focusable region table may include other columns with mapping information for other possible navigation key inputs. For example, a column for an upper right direction, upper left, lower right, or lower left or other direction may be included within a focusable region table.

FIG. 8A illustrates one embodiment of a method 800 for calculating the center of a first rectangle within a focusable region. Method 800 begins with determining the upper left corner coordinates of the first rectangle within the focusable region at step 810. FIG. 8B illustrates a focusable region 870 to which the which the process of method 800 can be applied. As illustrated in region 870, the upper-left corner coordinates of the first rectangle of the region is illustrated as point 842. In one embodiment, the upper left corner coordinate of the region is retrieved from the interface generator (for example, a web browser application). Returning to method 800, the length of the first rectangle of the region is determined at step 820. Once the length is determined, the width of the first rectangle is determined at step 830. The length/and width w of the first rectangle 840 of region 870 are illustrated in FIG. 8B. The center of the rectangle is then determined at step 835. In one embodiment, the center is determined to have coordinates of (x₁+l/2), (y₁+w/2). For example, if the first rectangle of a region had upper left corner corresponding to a pixel position of (x₁, y₁)=(210,310), a rectangle length of sixty pixels and a rectangle width of forty pixels, the center of the rectangle would have coordinates of (240, 330). In region 870 of FIG. 8B, the length and width of the first rectangle are illustrated. Also illustrated are lines drawn at the mid-point of the length, L/2, and the mid-point of the width, W/2. The intersection of these lines is determined to be the center of the rectangle. The center of the rectangle is marked by point 844.

Method 900 of FIG. 9 illustrates one embodiment of a method for firing a mouse-move event to a center of a rectangle within a focusable region as discussed above at step 548 of FIG. 5. The center of the rectangle is determined in step 840 of method 800 as discussed above. The x-coordinate of the rectangle is accessed at step 910. This x-coordinate will be the new x-axis pixel position of the cursor associated with the mouse. Next, the y-coordinate of the rectangle is accessed at step 920. The y-coordinate of the center of the rectangle will be used to indicate the new y-axis pixel position of the cursor. After the x and y-coordinates of the center of the first rectangle have been accessed, a mouse-move event is fired with the x-y pixel positions at step 930. Step 930 generates a mouse-move event normally generated in response to input received from a mouse input device. As a result of generating the event at step 930, the application of the present invention will emulate an event sent by the operating system. Thus, an event is sent to another application, which may fire an appropriate event to a hosted web page or some other application object.

FIG. 10 illustrates one embodiment of a keyboard 1000 used with the present invention. Keyboard 1000 includes keyboard casing 910, left arrow key 920, down arrow key 930, right arrow key 940, up arrow key 950, and focusable region select key 960. Arrow keys 920-950 can be mapped as navigation keys by an application processing the keyboard input. When depressed by a user, the navigation keys can be used to navigate from one a focused region to another focusable region. The focusable region select key can be mapped by an application processing the keyboard input to initiate firing of mouse events associated with a right mouse button. When depressed, the focusable region select key can initiate a function associated with a focusable region as discussed above.

The foregoing detailed description of the invention has been presented for purposes of illustration and description. It is not intended to be exhaustive or to limit the invention to the precise form disclosed. Many modifications and variations are possible in light of the above teaching. The described embodiments were chosen in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

We claim:

1. A method for synthesizing pointer events in a user interface, comprising:
receiving input from a keyboard;
selecting a focusable region within a user interface from the input; and
generating one or more pointer events associated with the focusable region.

2. The method of claim 1, wherein the input includes region select input, said selecting includes selecting a current focused region.

3. The method of claim 2, wherein the region select input is associated with a virtual key code.

4. The method of claim 1, wherein input includes navigational input.

5. The method of claim 4, wherein the pointer events include a move-mouse event.

6. The method of claim 4, further comprising:
determining a cursor point within the focusable region.

7. The method of claim 6, wherein determining the cursor point includes determining the focusable region from the navigational input.

8. The method of claim 6, wherein the cursor point is the center of the focusable region.

9. The method of claim 1, wherein the pointer event includes a mouse-move event to the focusable region.

10. The method of claim 1, further comprising:
providing the pointer event to an application object

11. A method for processing input by a browser, comprising:
receiving navigation input;
selecting a focusable region within an interface from the navigation input, the interface provided by a browser;
determining a cursor point within the focusable region and
generating one or more pointer events associated with the cursor point.

12. The method of claim 11, wherein selecting a focusable region includes selecting a focusable region other than the currently the focused region.

13. The method of claim 11 wherein the pointer events include a move-mouse event.

14. The method of claim 11, wherein the cursor point is the center of the focusable region.

15. The method of claim 11, wherein determining the cursor point includes retrieving focusable region information.

16. One or more processor readable storage devices having processor readable code embodied on one or more said processor readable storage devices, said processor readable code for programming one or more processors to perform a method, the method comprising:
receiving input from a keyboard;
determining a focusable region within an interface from the input; and
generating pointer events associated with the focusable region.

17. The one or more processor readable storage devices of claim 16, wherein the input includes region select input, said determining includes determining the current focusable region.

18. The one or more processor readable storage devices of claim 17, wherein the region select input is associated with a virtual key code.

19. The one or more processor readable storage devices of claim 16, wherein input includes navigational input, said determining includes selecting the current focusable region.

20. The one or more processor readable storage devices of claim 19, wherein the method includes:
selecting a cursor point within the focusable region.
